(19) United States
(12) Patent Application Publication
(10) Pub. No.: US 2024/0375919 A1
(43) Pub. Date: Nov. 14, 2024

(54) Rotary Drive Device

(71) Applicant: Walter FÖCKERSPERGER, Pauluszell/Ndb. (DE)

(72) Inventor: Daniel Föckersperger, Pauluszell/Ndb. (DE)

(21) Appl. No.: 18/690,170

(22) PCT Filed: Sep. 29, 2022
(86) PCT No.: PCT/EP2022/077103

§ 371 Date: Mar. 7, 2024

(30) Foreign Application Priority Data
Oct. 4, 2021 (DE) 20 2021 105 349.6

(51) Int. Cl. B66D 1/24; B66D 1/08

(52) U.S. Cl. CPC B66D 1/24; B66D 1/08

(57) ABSTRACT

The invention relates to a rotary drive for a drum in a winch on a support frame that has two parallel rotary piston motors that can be operated independently, each of which has a housing and a shaft. The housings are each connected to the drum for conjoint rotation. There is a reversible freewheel coupling between the shafts and the support frame in the force-transferring path, with which the respective shafts can be connected to the support frame for transferring forces.

### BACKGROUND OF THE INVENTION

### Field of the Invention

The present invention relates to a rotary drive device, in particular a winch drive for rotating a drum, in particular for a winch in a support frame.

### Description of Related Art

These winches are used to tow heavy agricultural machinery, e.g. pipe-and-cable-laying plows, with which flexible cables, e.g. electrical cables, lightning protection cables, barrier tapes, cover bands, pipes, etc. are placed in the ground. WO 03/053821 A1 discloses a mobile winch assembly that contains a winch, a drum supported on an axle onto which a cable is wound, and a support frame for the drum axle. The support frame is attached to carriage of a tractor, such that the winch is supported by the frame on the carriage. The drive in the form of an electric or hydraulic motor is located in the drum, and there is a coupling between the drive and the drum.

Although the winch assembly in WO 03/053821 A1 can be used for relatively heavy loads of up to 80 tons, and large torques can be obtained, there is room for improvement with regard to accommodating heavier loads and greater torques more smoothly at lower rotational rates.

### SUMMARY

Based on WO 03/053821 A1, the object of the invention is to therefore to create a rotary drive that can accommodate heavier loads and torques at lower rotational rates, which runs particularly smoothly.

This problem is solved by a rotary drive according to claim 1. Advantageous developments of the invention are the subject matter of the dependent claims 2 to 13.

The rotary drive according to the invention, in particular in the form of a drive for a winch drum, in particular a winch in a support frame, is distinguished by two independent, parallel rotary piston motors, each of which has a housing and a shaft. The housings are each connected to the drum for conjoint rotation. There is a reversible freewheel coupling between the shafts and the support frame with which the respective shafts can be connected to the support frame for transferring a force.

In a preferred embodiment, each of the rotary piston motors, which can also be referred to as rotary vane motors, is a hydraulic motor. In an alternative embodiment, a fluid motor, e.g. a pneumatic motor, can be used instead of the hydraulic motor. The shaft passes through the rotary piston motor housings. Diametrically opposed working pistons are connected to the housings for conjoint rotation, and diametrically opposed support pistons are connected to the shaft for conjoint rotation. The working and support pistons alternate around the shaft, such that a sealed pressure chamber is formed between each working piston and each support piston. Both the working pistons and the support pistons have an arc segment cross section when viewed along the rotational axis of the shaft. When hydraulic fluid (or some other fluid such as pressurized air) enters the pressure chamber, the working pistons can bear against the support pistons such that they rotate about the shaft. This requires that rotation of the shaft with the support pistons connected thereto for conjoint rotation is prevented. The working pistons connected to the drum for conjoint rotation cause the drum in the rotary drive to rotate, such that a hauling cable attached to a pipe-and-cable-laying plow can be wound up or wound out.

Initially, a first working piston is immediately in front of a first support piston, and a second working piston is immediately in front of a second support piston in the rotary piston motor. When hydraulic fluid enters a first pressure chamber formed between the first working piston and the first support piston, and a second pressure chamber formed between the second working piston and second support piston, the drum rotates, and the rotary piston motor applies a torque. The working pistons can only rotate until the first working piston comes in contact with the second support piston, and the second working piston comes in contact with the first support piston. The support pistons are then returned to their initial positions. During this recuperation phase, the motor cannot apply torque to the drum. To obtain a continuous torque, the substantially identical second rotary piston motor applies a torque to the drum during the recuperation phase of the first rotary piston motor. The positions in all of the pairs of pistons in the two rotary piston motors are monitored by rotary sensors. Hydraulic valves that regulate the supply of hydraulic fluid to and from the pressure chambers are controlled by a programable logic controller (PLC) such that one of the two rotary piston motors is always applying a torque, while the other is in the recuperation phase.

There is a freewheel coupling between each of the shafts and the support frame for the rotary drive. The freewheel couplings are reversible, i.e. they can prevent rotation of the shafts in each direction, and allow rotation in the other direction, and vice versa. This reversibility is necessary to be able to apply torques to the drums in both directions. When the freewheel coupling is disengaged, the shafts can rotate in both directions, and no force is transferred from the shafts to the support frame. Depending on whether the rotary piston motors are in the torque application phase or the recuperation phase, the PLC acts on the freewheel coupling such that force can be transferred between the shaft and the support frame in the torque application phase, and the working pistons bear on the support pistons, or no force is transferred between the shaft and the support frame during the recuperation phase, and the support pistons can return to their initial positions.

The rotary drive according to the invention is designed to support heavy loads and maintain torques for long periods at low rotational rates, and runs particularly smoothly due to the synchronized rotary piston motors and freewheel couplings. The rotary drive according to the invention applies high torques at low rotational rates without any additional gearing.

The two rotary piston motors can be placed axially between the two freewheel couplings. This results in a symmetrical and compact structure for the rotary drive.

The freewheel couplings can be fully disengaged, such that no force is transferred to the support frame. In the disengaged state, the motor shafts with the support pistons connected thereto for conjoint rotation can rotate freely in both directions. The freewheel couplings can be disengaged when the hauling cable is released after it has been wound onto the drum.

The freewheel couplings can have housings attached to the support frame. The freewheel couplings can be inside or outside the drum.

The freewheel couplings can each contain a rotor that is connected to the shaft for conjoint rotation, which can be connected to the coupling housing for force transfer by a coupling element. The coupling elements can be activated synchronously.

The freewheel couplings can have pawls. The coupling elements are the pawls in this case. The pawls can bear on teeth formed on the coupling housings, to prevent rotation of the shafts in either direction. Other elements can also be used, instead of pawls, with which the force transfer path can be obtained or interrupted between the shafts and the support frame. It is only important that the elements are reversible, such that torques can be transferred in both directions to the drum.

The freewheel couplings can be switched from one setting to another with a fluid. It is also fundamentally possible for the freewheel couplings to be switched mechanically, pneumatically, or electromagnetically, etc. Fluid switching has the advantage that the fluid can be supplied by the same fluid circuit that is used for the hydraulic rotary piston motors.

The rotary drive can contain a fluid circuit with valves dedicated to the rotary piston motors and the freewheel couplings that controls the amount of fluid supplied thereto.

The rotary drive can contain an electronic control unit for the valve in the fluid circuit. This electronic control unit is preferably a programmable logic controller (PLC).

The control unit for the fluid circuit can be configured such that the rotary piston motors drive the drum continuously. In other words, the control unit can be programmed such that the rotary piston motors and the settings of the freewheel couplings are coordinated to one another such that while the drum is rotating, one of the two rotary piston motors is always applying a torque. This results in a more uniform rotation of the drum, such that it runs more smoothly.

The control unit can also be configured to control the fluid circuit such that the rotary piston motors cause the drum to rotate simultaneously. In other words, the rotary piston motors can be synchronized such that they are both applying torque at the same time, thus doubling the torque applied to the drum. This can only take place until the support pistons in the rotary piston motors must be returned to their initial positions behind the working pistons, i.e. approximately one half of a rotation.

The electronic control unit can contain a position sensor, e.g. a rotation sensor, that detects the rotational angle of the shafts in relation to the respective housings for the rotary piston motors. The positions of the working pistons and support pistons can be detected by this means, such that the operation of the rotary drive can be easily monitored.

The drum can be a tube in the rotary drive according to the invention, and the rotary piston motors can be placed inside the drum. This saves a lot of space, in particular when the freewheel couplings are also located within the drum. The motor housings can be round, such that they can be easily secured in place within the drum. The torque can consequently be transferred directly from the motor housings to the drum without additional gearing.

### BRIEF DESCRIPTION OF THE DRAWINGS

Preferred embodiments of the rotary drive according to the invention shall be explained below in reference to the drawings, in which

FIG. 1 shows a sectional view cut along a drum axis for a rotary drive according to the invention;

FIG. 2 shows front, sectional views looking along the arrows A-A, B-B, C-C and D-D in FIG. 1, at a first point in time, when the drum is rotating in the clockwise direction;

FIG. 3 shows front, sectional views looking along the arrows A-A, B-B, C-C, and D-D in FIG. 1 at a second point in time, when the drum is rotating in the clockwise direction;

FIG. 4 shows front, sectional views looking along the arrows A-A, B-B, C-C, and D-D in FIG. 1 at a third point in time, when the drum is rotating in the clockwise direction;

FIG. 5 shows front, sectional views looking along the arrows A-A, B-B, C-C, and D-D in FIG. 1 when the hauling cable is no longer active, after it has been wound onto the drum;

FIG. 6 shows a front view of a freewheel coupling according to the invention;

FIG. 7 shows front, sectional views looking along the arrows A-A, B-B, C-C, and D-D in FIG. 1 at a point in time when the drum is rotating in the counterclockwise direction; and

FIG. 8 shows a sectional view cut along the drum axis in the rotary drive according to the invention.

### DETAILED DESCRIPTION

### Structure of the Rotary Drive 1

FIG. 1 shows a rotary drive 1 for a tube drum 3 in a winch on a support frame 5. The support frame 5 is mounted on the carriage of a tractor, not shown in the drawings. A hauling cable can be wound up and wound out on the drum 3, to which a pipe-and-cable-laying plow, for example, is attached, with which flexible material, e.g. power cables, lightning protection cables, barrier tapes, cover bands, pipes, etc. can be placed in the ground. The drum 3 is supported on the frame 5 by cylindrical roller bearings 2 in this embodiment.

The rotary drive 1 has two parallel rotary piston motors that can be operated independently, a first rotary piston motor 10 and a second rotary piston motor 30, which are substantially identical. These rotary piston motors 10, 30 are hydraulic motors, which are operated with hydraulic fluid supplied by a fluid circuit, not shown in the drawings.

The first rotary piston motor 10 has a housing 12 that is connected to the drum 3 for conjoint rotation, and can apply a torque to the drum 3. A shaft 14 passes through the housing 12 at one end, and has a pawl freewheel coupling 20 at the other end that has a housing 22 attached to the support frame 5. The shaft 14 is supported by double cylindrical roller bearings on the support frame 5 and a bearing segment 7 inside the drum 3.

The second rotary piston motor 30 also has a housing 32 that is connected to the drum 3 for conjoint rotation and can apply a torque to the drum 3. A second shaft 15 passes through the housing 32 at the end facing the first shaft 14, and has a pawl freewheel coupling 40 at its other end that has a housing 42 attached to the support frame 5. The shaft 15 is supported on the frame 5 by double cylindrical roller bearings and the bearing segment 7 inside the drum 3.

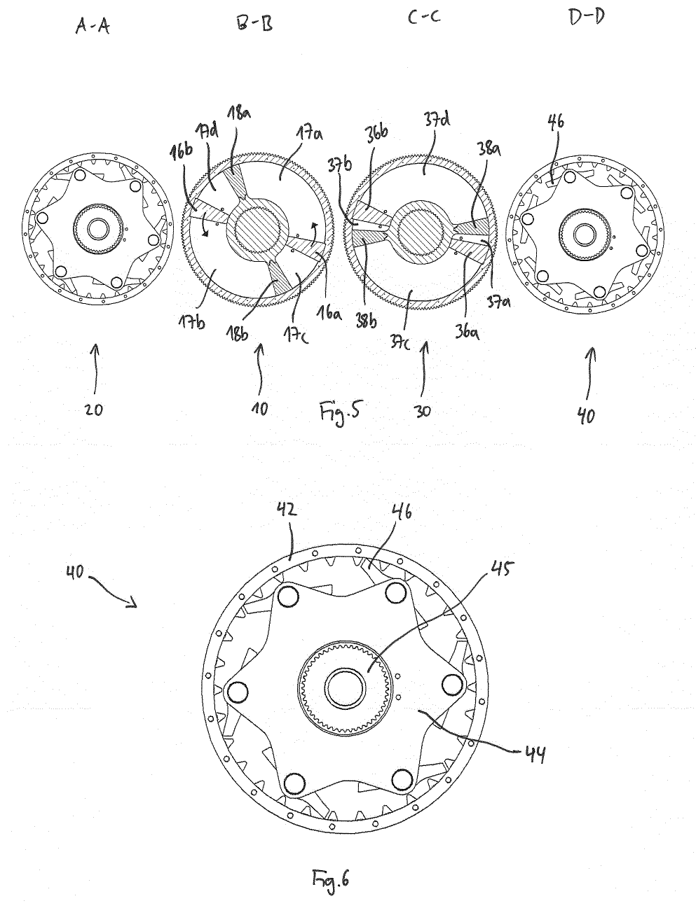

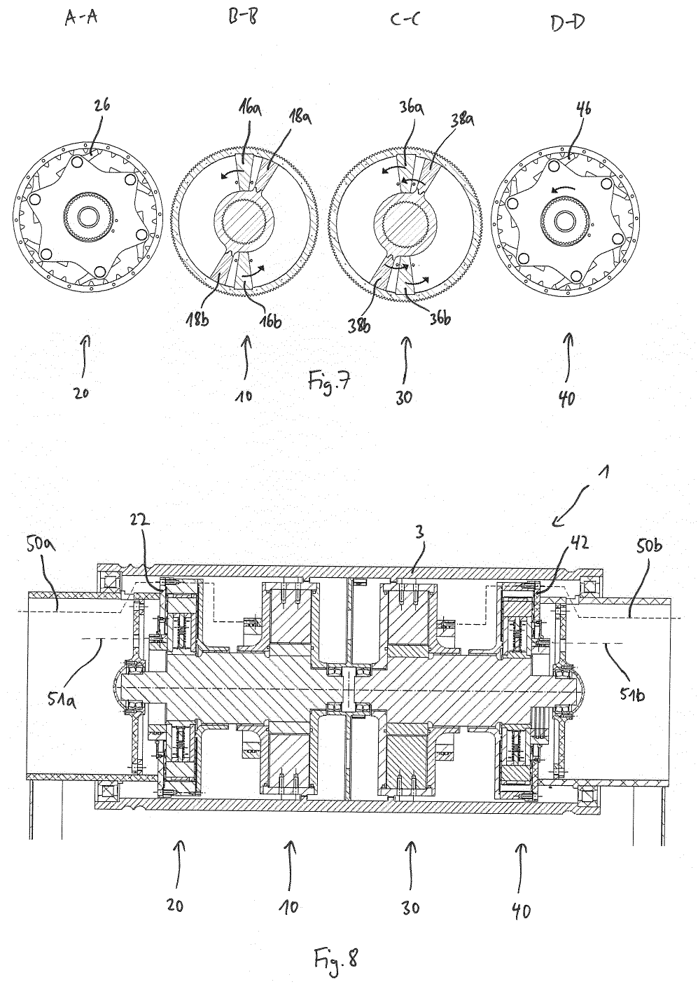

FIG. 2 shows front views of the two freewheel couplings 20, 40 looking along the arrows A-A and D-D in FIG. 1. The freewheel couplings 20, 40 each have star-shaped coupling rotors 24, 44 that are connected to the respective shafts 14, 15 by a spline for conjoint rotation. Reversible pawls 26, 46 are attached to the coupling rotors 24, 44, which can be synchronously switched between three settings by a switching wheel. In the first setting shown in FIG. 2, the pawls 26, 46 bear at one end on teeth formed on an inner circumference of the respective coupling housing 22, 42. Counterclockwise Rotation of the coupling rotors 24, 44 and the shafts 14, 15 is blocked in the first setting. The coupling rotors 24, 44 and shafts 14, 15 can rotate in the clockwise direction. In a second setting, the pawls 26, 46 bear at their other end on the teeth formed on the inner circumference of the respective coupling housings 22, 42. Clockwise rotation of the coupling rotors 24, 44 and the shafts 14, 15 is blocked in the second setting (see FIG. 7). The coupling rotors 24, 44 and shafts 14, 15 can rotate in the counterclockwise direction. The pawls 26, 46 are fully disengaged in a third setting (see section D-D in FIG. 5), such that neither of their ends bear on the teeth in the coupling housing 22, 42. The coupling rotors 24, 44 and shafts 14, 15 can rotate freely in both directions in this setting. The pawls 26 in the first freewheel coupling 20 and the pawls 46 in the second freewheel coupling 40 can be independently switched synchronously to any of the three settings, with which a force-transferring connection between the shafts 14, 15 and the coupling housings 22, 42 and the support frame 5 can be obtained or interrupted. This switching between the settings of the pawls 26, 46 is obtained hydraulically. The fluid circuit, not shown in the drawings, is controlled electronically for this by a programmable logic controller (PLC).

FIG. 2 also shows sectional views of the two rotary piston motors 10, 30 looking along the arrows B-B and C-C in FIG. 1. The rotary piston motor 10 has two diametrically opposed working pistons 16a, 16b, which are connected to the motor housing 12 for conjoint rotation, and two diametrically opposed support pistons 18a, 18b that are connected to the shaft 14 by a ring 13 with inner teeth for conjoint rotation. The working pistons 16a, 16b, motor housing 12, support pistons 18a, 18b, and ring 13 with inner teeth are separate components. The working pistons 16a, 16b and the motor housing 12 could also form an integral component, and/or the support pistons 18a, 18b and ring 13 with inner teeth could also form an integral component. Both the working pistons 16a, 16b and support pistons 18a, 18b have an arc segment cross section when viewed along the rotational axis of the shaft 14. There are pressure chambers 17a to 17d between the working pistons and support pistons, into which a hydraulic fluid can be supplied by a hydraulic valve controlled by the PLC in a fluid circuit, not shown. The substantially identical second rotary piston motor 30 also has two diametrically opposed working pistons 36a, 36b, which are connected to the motor housing for conjoint rotation, and two diametrically opposed support pistons 38a, 38b, which are connected to the shaft 15 for conjoint rotation. There are pressure chambers 37a to 37d between the working pistons and the support pistons.

### Functioning of the Rotary Drive 1

The functioning of the rotary drive 1 according to the invention in accordance with the preferred embodiment shall be explained below in reference to FIGS. 2 to 4.

The initial state for the description of the functioning is an unloaded and wound out hauling cable, to which the pipe-and-cable-laying plow is attached. The tractor pulls the pipe-and-cable-laying plow toward it. This corresponds to a rotation of the motor housings 12, 32 and the drum 3 attached thereto for conjoint rotation in the clockwise direction in FIGS. 2 to 4. Before the rotary drive 1 can generate rotation in the clockwise direction, the pawls 26, 46 bear on the teeth in the respective coupling housings 22, 42, as shown in FIG. 2. Counterclockwise rotation of the shafts 14, 15 is thus prevented.

Hydraulic fluid is subsequently fed at a high pressure of up to 350 bar into the pressure chamber 17a between the working piston 16a and the support piston 18a, and the pressure chamber 17b between the working piston 16b and the support piston 18b. Because counterclockwise rotation of the support pistons 18a and 18b and the shaft 14 is prevented by the freewheel coupling 20, the working pistons 16a and 16b can bear on the support pistons 18a and 18b, and rotate in the clockwise direction, as indicated by the arrows in FIG. 2. The first rotary piston motor 10 applies a torque, causing the motor housing 12 and drum 3 to rotate in the clockwise direction, such that the hauling cable can be wound up. While hydraulic fluid is fed into the pressure chambers 17a and 17b, hydraulic fluid is drained from the pressure chambers 17c and 17d. The working pistons 36a, 36b in the second rotary piston motor 30 are connected indirectly to the working pistons 16a, 16b in the first rotary piston motor 10 by the drum 3. The hydraulic valves in the second rotary piston motor 30 are closed when the first rotary piston motor 10 is applying torque. No hydraulic fluid is fed into or drained from the pressure chambers 37a to 37d. Consequently, both the working pistons 36a, 36b and the support pistons 38a, 38b in the second rotary piston motor 30 rotate in the clockwise direction. The freewheel coupling 40 is in a first setting in which the pawls 46 and the coupling rotor 44 can rotate freely in the clockwise direction, and rotation of the shaft 15 is not blocked.

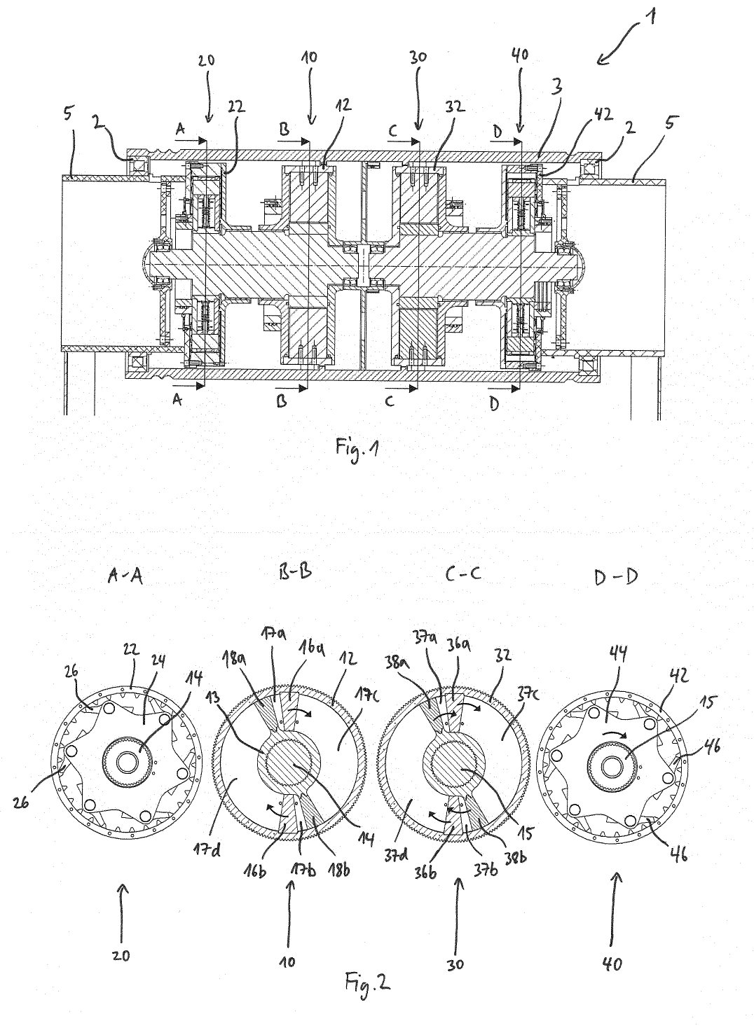

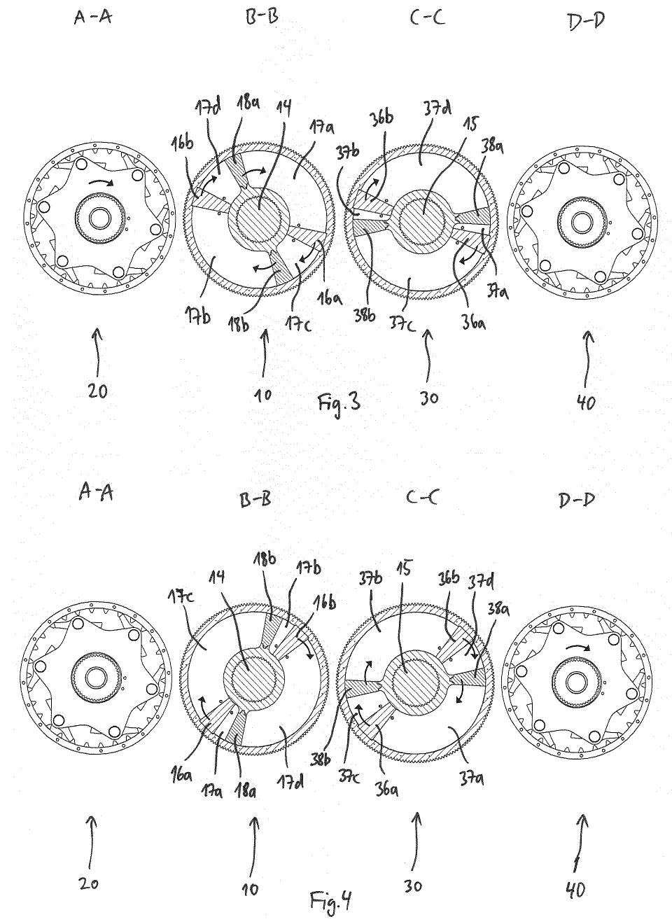

While torque is being applied, the working pistons 16a, 16b can only pivot or rotate until the working piston 16a comes in contact with the support piston 18b in front of it, and the working piston 16b comes in contact with the support piston 18a in front of it. The support pistons 18a, 18b must subsequently be returned to their respective starting positions behind the working pistons 16a, 16b. During this recuperation phase, the first rotary piston motor 10 cannot apply any torque to the drum 3. To obtain a continuous torque, the substantially identical second rotary piston motor 30 generates the torque applied to the drum 3 while the first rotary piston motor 10 is in the recuperation phase, as shown in FIG. 3. Hydraulic fluid is fed into the pressure chamber 37a between the working piston 36a and the support piston 38a and the pressure chamber 37b between the working piston 36b and the support piston 38b. Because the freewheel coupling 40 prevents counterclockwise rotation of the support pistons 38a and 38b and the shaft 15, the working pistons 36a and 36b can bear on the support pistons 38a and 38b, and rotate in the clockwise direction, as indicated by the arrows in FIG. 3. The second rotary piston motor 30 applies torque to the drum 3 in this phase. The working pistons 16a, 16b rotate in the clockwise direction due to the rotation of the drum 3. The support pistons 18a, 18b are returned to their initial positions by feeding hydraulic fluid into the pressure chambers 17c and 17d. Consequently, the support pistons 18a, 18b rotate with the coupling rotor 24 in the freewheel coupling 20 in the clockwise direction, until they reach the position shown in FIG. 4. The recuperation phase for the first rotary piston motor 10 must be completed before the working piston 36a comes in contact with the support piston 38b in front of it, and the working piston 36b comes in contact with the support piston 38a in front of it. Shortly before completion of the torque application phase in the second rotary piston motor 30, hydraulic fluid is fed into the pressure chambers 17a and 17b in the first rotary piston motor 10, at which point the first rotary piston motor 10 transitions from the recuperation phase to the torque application phase, and again generates a torque applied to the drum 3.

The steps described above can be repeated as often as necessary, until the hauling cable is fully wound onto the drum 3. The torque M generated by a rotary piston motor during the torque application phase can be calculated with the formula

M=2*p*A*l

in which p is the pressure of the hydraulic fluid in the pressure chambers, A is the surface area of the piston, and l describes a perpendicular lever arm from the rotational axis of the shaft 14 or 15 to a center of gravity of the respective piston surface. The pressure p of the hydraulic fluid in the pressure chambers can be detected by pressure sensors, not shown in the drawings. The positions of all of the pairs of pistons in the rotary piston motors 10, 30 during operation are monitored by rotary sensors.

After the hauling cable has been fully wound onto the drum 3, it is detached from its load, as indicated in FIGS. 5 and 6. It is assumed that the first rotary piston motor 10 is the last one that applied torque. To allow the working pistons 16a, 16b to rotate counterclockwise, such that the hauling cable can be detached from its load, the pawls 46 in the freewheel coupling 40 must be released, to allow rotation in both directions. The pawls 46 can only be released when they are not in contact with the teeth in the coupling housing 42. When they are in contact with the teeth, the first rotary piston motor 10 continues to apply torque, such that the pawls 46 are released from teeth in the coupling housing 42 and can be pivoted to the released setting, as shown in FIG. 6. This step is automatically implemented by the PLC in the rotary drive. Pressure can then be built up in the pressure chambers 17a and 17b, thus rotating the drum 3 in the counterclockwise direction, releasing the tension in the hauling cable. This process can only be carried out until the working pistons 16a, 16b in the first rotary piston motor 10 come in contact with the support pistons 18a and 18b in front of them. If the hauling cable is still not released at this point, the pawls 46 in the freewheel coupling 40 are again tilted in the clockwise direction. The torque generated by the tension in the cable is subsequently supported by the pressure accumulated in the pressure chambers 37a to 37d in the second rotary piston motor 30. This allows for the support pistons 18a, 18b in the first rotary piston motor 10 to be repositioned, such that the tension can be released from the hauling cable.

It is also possible to rotate the drum 3 in the counterclockwise direction with the rotary drive 1 according to the invention. To generate a continuous rotation in the counterclockwise direction, the sequence of the steps described above remains substantially the same. Only the initial positions of the support pistons 16a, 16b in the first rotary piston motor 10, the support pistons 36a, 36b in the second rotary piston motor 30, and the positions of the pawls 26, 46 are changed, as shown in FIG. 7.

The courses of the hydraulic lines 50a and 5b in the fluid circuit for the pressure chambers 17a to 17d and 37a to 37d in the rotary piston motors 10, 30 are indicated by a broken line in FIG. 8. As can be seen in FIG. 8, the hydraulic lines 50a and 50b pass through the coupling housings 22, 42 to the pressure chambers in both rotary piston motors 10, 30 from outside the drum 3. The other hydraulic lines 51a, 51b in the fluid circuit that supply fluid to the freewheel couplings 20, 40 are schematically indicated by broken lines.

The invention claimed is:

1. A rotary drive, in particular a winch drive for rotating a drum, in particular a winch supported on a frame, the drive comprising:
two parallel rotary piston motors that can be operated independently, each of which has a housing and a shaft; and wherein,
the motor housings are each connected to the drum for conjoint rotation; and wherein,
reversible freewheel couplings are placed in the force-transfer path between the shafts and the support frame, and wherein,
the respective shafts are connected to the support frame in a force-transferring manner.

2. The rotary drive according to claim 1, wherein the two rotary piston motors are located axially between the two freewheel couplings.

3. The rotary drive according to claim 1, wherein the freewheel couplings can be fully released, such that no forces are transferred to the support frame.

4. The rotary drive according to claim 1, wherein the freewheel couplings each have a housing that is connected to the support frame for conjoint rotation.

5. The rotary drive according to claim 4, wherein the freewheel couplings each have a coupling rotor connected to the shafts for conjoint rotation, which can be connected for force transfer to the coupling housings by coupling elements that can be switched to different settings.

6. The rotary drive according to claim 1, wherein the freewheel couplings are each pawl freewheel couplings.

7. The rotary drive according to claim 5, wherein the freewheel couplings can each be switched between settings by means of a fluid.

8. The rotary drive according to claim 7, further comprising a fluid circuit with the rotary piston motors and valves dedicated to the freewheel couplings for controlling the fluid supply to the rotary piston motors and the freewheel couplings.

9. The rotary drive according to claim 8, further comprising an electronic control unit for the valves in the fluid circuit.

10. The rotary drive according to claim 9, wherein the control unit for the fluid circuit is configured such that the rotary piston motors continuously drive the drum.

11. The rotary drive according to claim 10, wherein the control unit is configured to control the fluid circuit such that the rotary piston motors drive the drum simultaneously.

12. The rotary drive according to claim 9, wherein the electronic control unit contains position sensors for detecting the angular positions of the shafts in relation to the respective housings for the rotary piston motors.

13. The rotary drive according to claim 1, wherein the drum is a drum tube, and the rotary piston motors are in the drum tube.
